(19) United States
(12) Patent Application Publication
(10) Pub. No.: US 2012/0300074 A1
(43) Pub. Date: Nov. 29, 2012

(54) DETECTION APPARATUS AND DETECTION METHOD

(75) Inventor: Keiichi HASEGAWA, Yokohama-shi (JP)

(73) Assignee: Honda elesys Co., Ltd. of YBP Hi-tech Center, Yokohama-shi (JP)

(21) Appl. No.: 13/450,111

(22) Filed: Apr. 18, 2012

(30) Foreign Application Priority Data
Apr. 19, 2011 (JP) P2011-092843

(51) Int. Cl. H04N 7/18

(52) U.S. Cl. 348/148; 348/E07.085

(57) ABSTRACT

A detection apparatus includes a control unit configured to switch an exposure time of an imaging device at a predetermined time, an image acquiring unit configured to acquire image data captured under different exposure times, and an object detecting unit configured to detect objects from the image data of the different exposure times acquired by the image acquiring unit.

### CROSS-REFERENCE TO RELATED APPLICATIONS

Priority is claimed on Japanese Patent Application No. 2011-92843, filed Apr. 19, 2011, the contents of which are entirely incorporated herein by reference.

### BACKGROUND OF THE INVENTION

1. Field of the Invention

The present invention relates to a detection apparatus mounted on a traveling vehicle and a detection method.

2. Background Art

A detection apparatus detecting a vehicle traveling lane marking line (a white line on a road) extracts predetermined feature points from an image captured by an imaging device mounted on a vehicle and extracts segments corresponding to a traveling lane marking line based on the extracted feature points. The detection apparatus compares the extracted segments corresponding to a traveling lane marking line with a model of a traveling lane marking line stored in advance and selects a segment matching with the model. The detection apparatus approximates the feature points corresponding to the selected segment to calculate a traveling lane marking line and detects an object (refer, for example, to JP-A-08-315125 (Patent Document 1)).

In the detection apparatus, when objects are detected by imaging during the daytime, the image is captured under an exposure time of an imaging device shortened so as not to saturate the captured image. When objects are detected by imaging at night, the image is captured under an exposure time lengthened as much as possible so as to clearly capture the image of a traveling lane marking line which is an object.

However, the technique described in Patent Document 1, since the exposure time is lengthened when objects are detected by imaging at night, the light intensity of a light source of headlights is excessively great and thus the captured image is saturated when recognizing an oncoming vehicle with the headlights on. When the exposure time is shortened to prevent saturation of the captured image, the image obtained by imaging objects such as a traveling lane marking line does not have satisfactory luminance and thus unclear image data is obtained. Accordingly, objects such as a traveling lane marking line cannot be appropriately recognized.

The invention is made in consideration of such a problem and an object thereof is to provide a detection apparatus and a detection method, which can appropriately detect a traveling lane marking line and headlights even at night.

### SUMMARY OF THE INVENTION

To achieve the above-mentioned object, according to a first aspect of the invention, there is provided a detection apparatus including: a control unit configured to switch the exposure time of an imaging device at a predetermined time; an image acquiring unit configured to acquire image data captured under different exposure times; and an object detecting unit configured to detect objects from the image data of the different exposure times acquired by the image acquiring unit.

In the detection apparatus, the control unit may be configured to switch the amplification sensitivity of the imaging device at a predetermined time, the image acquiring unit may be configured to acquire image data captured under different exposure times and different amplification sensitivities, and the object detecting unit may be configured to detect objects from the image data of the different exposure times and the different amplification sensitivities acquired by the image acquiring unit.

The detection apparatus may further include: an area extracting unit configured to extract image data of candidate areas of the objects from the image data captured under the different exposure times; an absolute luminance calculating unit configured to calculate the absolute luminance in the image data of the candidate areas of the objects extracted by the area extracting unit; and a correction unit configured to correct at least one of the exposure time and the amplification sensitivity based on the absolute luminance in the image data of the candidate areas of the objects calculated by the absolute luminance calculating unit, and the control unit may be configured to switch the exposure time or amplification sensitivity of the imaging device to the exposure time or amplification sensitivity corrected by the correction unit.

In the detection apparatus, the different exposure times may include a first exposure time and a second exposure time shorter than the first exposure time.

In the detection apparatus, the first exposure time may be an exposure time used to detect at least a light-emitting object, and the second exposure time may be an exposure time used to detect at least a reflecting object.

In the detection apparatus, the light-emitting object may be at least a headlight, and the reflecting object may be an object including any one of a traveling lane marking line, a vehicle, and a person on a vehicle traveling road.

According to a second aspect of the invention, there is provided a detection method in a detection apparatus, including: a control step of causing a control unit to switch the exposure time of an imaging device at a predetermined time; an image acquiring step of causing an image acquiring unit to acquire image data captured under different exposure times; and an object detecting step of causing an object detecting unit to detect objects from the image data of the different exposure times acquired in the image acquiring step.

According to the invention, since objects are detected from image data captured under different exposure times, it is possible to detect a traveling lane marking line having a low luminance even at night and to appropriately detect headlights without causing saturation.

### BRIEF DESCRIPTION OF THE DRAWINGS

FIG. 1 is a block diagram illustrating an example of the constitution of a recognition apparatus according to a first embodiment of the invention.

FIG. 2 is a diagram illustrating the relationship between an imaging target and an exposure time according to the first embodiment.

FIG. 3 is a schematic diagram illustrating an example of a frame image captured under a relatively-long exposure time A by the use of a detection apparatus according to the first embodiment.

FIG. 4 is a schematic diagram illustrating an example of a frame image captured under a relatively-short exposure time B by the use of the detection apparatus according to the first embodiment.

FIG. 5 is a flowchart illustrating the operation of the detection apparatus according to the first embodiment.

FIG. 6 is a conceptual diagram illustrating the IRIS used in a known detection apparatus.

FIG. 7 is a block diagram illustrating an example of the constitution of a detection apparatus according to a second embodiment of the invention.

FIG. 8 is a diagram illustrating the relationship among an imaging target, an exposure time, and a gain according to the second embodiment.

FIG. 9 is a flowchart illustrating the operation of the detection apparatus according to the second embodiment.

### DETAILED DESCRIPTION OF THE INVENTION

Hereinafter, embodiments of the invention will be described with reference to the accompanying drawings. The invention is not limited to the embodiments but can be modified in various forms without departing from the technical scope thereof. In the drawings described below, the scale between the actual structures and structures varies, for the purpose of easy understanding of the structures.

First, the operation of a detection apparatus according to the invention will be described in brief. The detection apparatus according to the invention brightly images a traveling lane marking line of a road surface at night (exposure time A: the exposure time is long) and images an oncoming vehicle with the same camera (exposure time B: the exposure time is short), by capturing an image with a single imaging device by alternately switching the exposure times A and B. Objects on the road are detected using image data captured under two exposure times.

The image data captured by the imaging device while the front side of a vehicle is illuminated with headlights attached to the front of the vehicle at night may include streetlights in addition to the traveling lane marking line. In order to extract the traveling lane marking line from the image data obtained by imaging this situation, a certain degree of luminance difference is necessary. Particularly, since the luminance difference becomes smaller at night, it is necessary to lengthen the exposure time. Since everything becomes shiny in the rain, it is difficult to acquire the luminance difference from the traveling lane marking line. When the time elapses after the traveling lane marking line is drawn, it is also difficult to acquire the luminance difference. In this case, it is necessary to elongate the exposure time.

On the other hand, the luminance of headlights is set to such a luminance to distinguish the traveling lane marking line at night. On the other hand, when the imaging device is a CMOS camera, the dynamic range is merely about 12 bits and 66 dB (decibel) and thus the luminance range in which the brightest place and the darkest place can be captured is limited. Accordingly, the imaging device is used in a range in which a high luminance can be measured during the daytime and is used in a range in which a dark place can be captured at night.

### First Embodiment

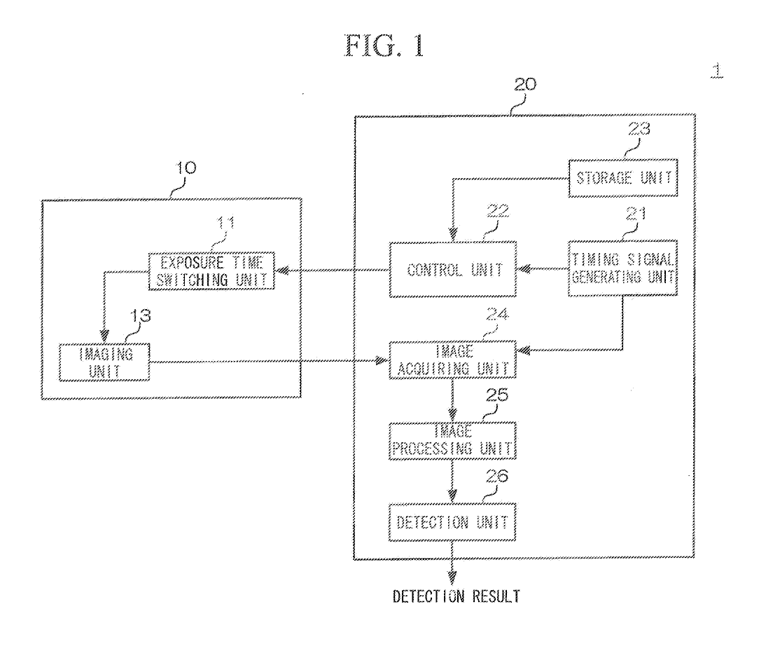

The constitution of a recognition apparatus according to a first embodiment of the invention will be described below with reference to FIG. 1. FIG. 1 is a block diagram illustrating an example of the constitution of the recognition apparatus according to the first embodiment.

As shown in FIG. 1, the recognition apparatus 1 includes an imaging device 10 and a detection apparatus 20.

The constitution of the imaging device 10 will be described below. The imaging device 10 includes an exposure time switching unit 11 and an imaging unit 13.

The exposure time switching unit 11 switches the exposure time of the imaging unit 13 based on information, which is output from the detection apparatus 20, representing the exposure time.

The imaging unit 13 is, for example, a CMOS (Complementary Metal Oxide Semiconductor) camera. The imaging unit 13 captures an image with the exposure time switched by the exposure time switching unit 11 and outputs the captured image data to the detection apparatus 20.

The constitution of the detection apparatus 20 will be described below. The detection apparatus 20 includes a timing signal generating unit 21, a control unit 22, a storage unit 23, an image acquiring unit 24, an image processing unit 25, and a detection unit 26.

The timing signal generating unit 21 generates a timing signal with a predetermined period and outputs the generated timing signal to the control unit 22 and the image acquiring unit 24. The predetermined period is, for example, 1 second.

The control unit 22 reads two exposure times of the exposure time A and the exposure time B stored in the storage unit 23. The control unit 22 outputs information representing the exposure time A and information representing the exposure time B at the time of the timing signal output from the timing signal generating unit 21.

The information representing the exposure time A and the information representing the exposure time B are stored in advance in the storage unit 23. The exposure time A is set to be relatively long and is used to image a traveling lane marking line or the like when detecting objects (including a traveling lane marking line, a vehicle, and a person) at night. On the other hand, the exposure time B is set to be shorter than the exposure time A and is used to image headlights which are strong light sources so as to avoid saturation.

The image acquiring unit 24 acquires image data output from the imaging device 10 at the time of the timing signal output from the timing signal generating unit 21 and converts the acquired image data to digital data. The image acquiring unit 24 outputs the converted image data to the image processing unit 25. When the image data output from the imaging device 10 is a digital signal, the image acquiring unit 24 outputs the acquired image data to the image processing unit 25 without converting the image data.

The image processing unit 25 performs a predetermined image process on the image data output from the image acquiring unit 24. The predetermined image process means the same process as described in Patent Document 1 when detecting a reflecting object (such as a traveling lane marking line, a vehicle, and a person). That is, the image processing unit 25 detects, for example, edge points in the image data to detect edge image data and performs a Hough transform on the edge image data to detect linear components. The image processing unit 25 detects continuous segments out of the detected linear components as candidates of the traveling lane marking line. When detecting headlights, for example, the image processing unit 25 detects edge points in the image data to detect edge image data and performs a Hough transform on the edge image data to detect circular components. Then, the image processing unit 25 detects the detected circular components as candidates of the headlights.

The image processing unit 25 outputs the information representing candidate areas of objects detected in this way to the detection unit 26.

The detection unit 26 detects light-emitting objects and reflecting objects based on the information representing the candidate areas of the objects output from the image processing unit 25. The detection unit 26 outputs the detection result to a display unit mounted on a dashboard not shown or a vehicle traveling control unit not shown. The vehicle traveling control unit not shown controls the traveling of the vehicle based on the information representing the detection result output from the detection apparatus 20.

In the first embodiment, an object detecting unit is constituted by the image processing unit 25 and the detection unit 26.

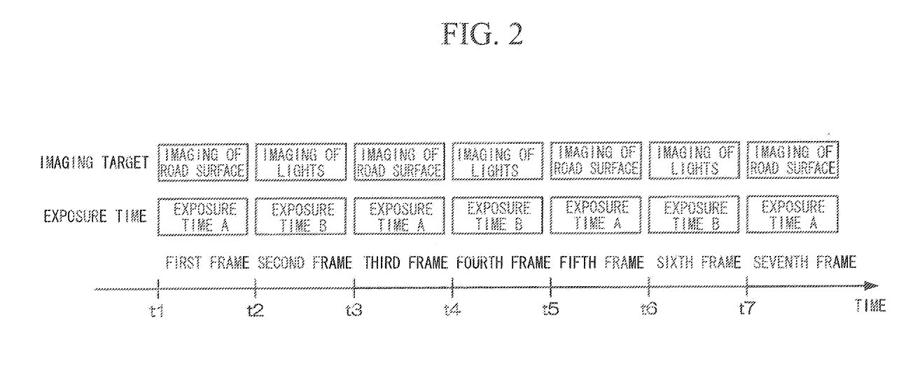

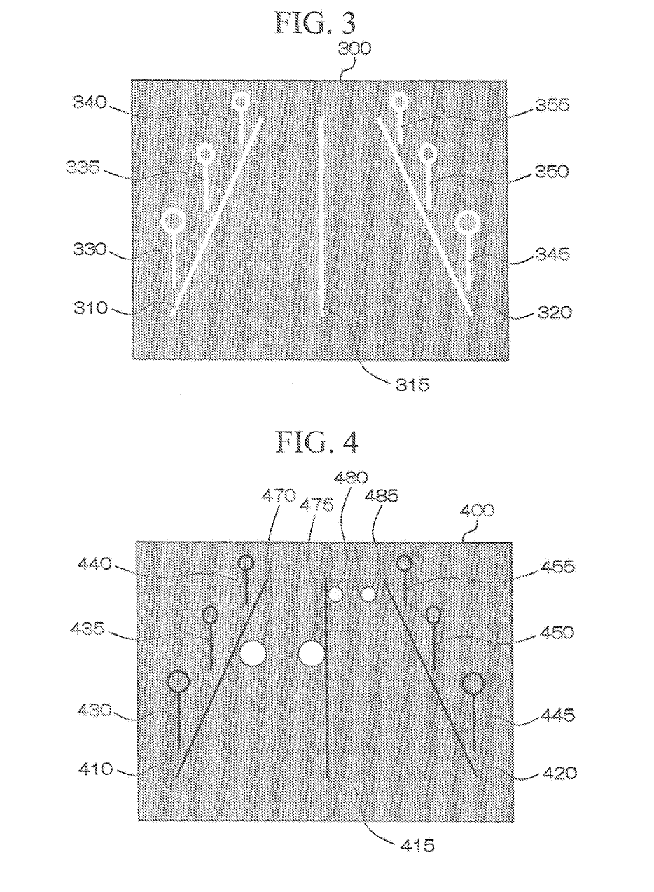

An imaging target and an exposure time will be described below with reference to FIGS. 2 to 4. FIG. 2 is a diagram illustrating the relationship between an imaging target and an exposure time according to the first embodiment. FIG. 3 is a schematic diagram illustrating an example of a frame image captured under a relatively-long exposure time A in the detection apparatus according to the first embodiment. FIG. 4 is a schematic diagram illustrating an example of a frame image captured under a relatively-short exposure time B in the detection apparatus according to the first embodiment.

As shown in FIG. 2, the imaging device 10 captures image data of a first frame with the exposure time A in the period of times t1 to t2 under the control of the detection apparatus 20. In this case, since the image is captured under the exposure time A which is a long exposure time, the imaging device 10 captures an image for detecting a road surface.

The imaging device 10 captures image data of a second frame with the exposure time B which is a short exposure time in the period of times t2 to t3 under the control of the detection apparatus 20. In this case, since an image is captured under the short exposure time B, the imaging device 10 captures an image for detecting lights such as headlights. Thereafter, the imaging device 10 alternately captures an image with the exposure time A and the exposure time B. The image data captured by the imaging device 10 is described as monochromatic image data, but the image data may be color image data.

In the first frame, the third frame, the fifth frame, and so on in FIG. 2, when an image is captured under the long exposure time A, traveling lane marking lines 310, 315, and 320 or streetlights 330 to 355 which are detection targets in image data 300 are captured as white images, as shown in FIG. 3, since they have high luminance.

On the contrary, in the second frame, the fourth frame, the sixth frame, and so on in FIG. 2, when an image is captured under the short exposure time B, circular areas 470 to 485 representing headlights which are detection targets in image data 400 are captured as white images, as shown in FIG. 4, since they have high luminance. That is, since the image data 400 is taken with the exposure time B, the headlights of an oncoming vehicle are captured without causing the saturation.

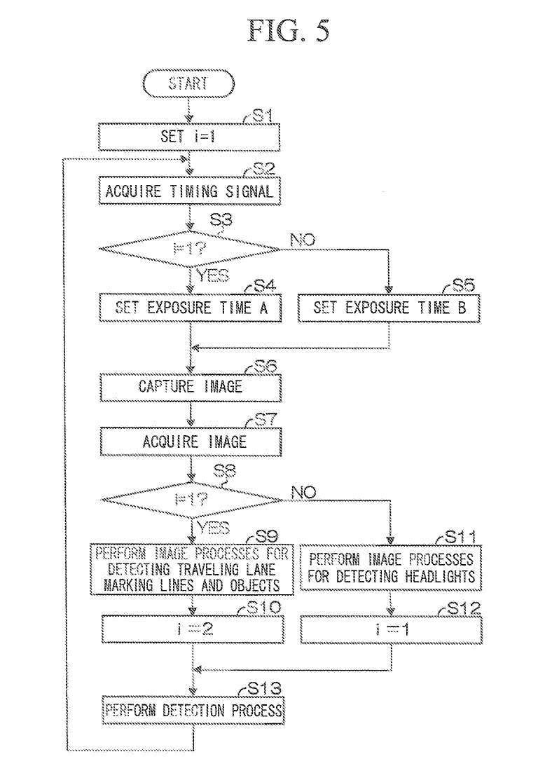

The operation in the first embodiment will be described below with reference to FIG. 5. FIG. 5 is a flowchart illustrating the operation of the detection apparatus according to the first embodiment.

(Step S1) The control unit 22 of the detection apparatus 20 first sets a variable i for determining which of the exposure times A and B to use to “1”. The processes of step S2 and subsequent steps thereof described below are performed for each frame. After the end of step S1, the flow of processes goes to step S2.

(Step S2) The control unit 22 acquires a timing signal output from the timing signal generating unit 21. After the end of step S2, the flow of processes goes to step S3.

(Step S3) The control unit 22 determines whether the variable i is 1. When it is determined that the variable i is 1 (Yes in step S3), the flow of processes goes to step S4. When it is determined that the variable i is not 1 (No in step S3), the flow of processes goes to step S5.

(Step S4) When it is determined that the variable i is 1 (Yes in step S3), the control unit 22 outputs the exposure time A out of the exposure times read from the storage unit 23 to the imaging device 10. After the end of step S4, the flow of processes goes to step S6.

(Step S5) When it is determined that the variable i is not 1 (No in step S3), the control unit 22 outputs the exposure time B out of the exposure times read from the storage unit 23 to the imaging device 10. After the end of step S5, the flow of processes goes to step S6.

(Step S6) The exposure time switching unit 11 of the imaging device 10 acquires information representing the exposure time A or B output from the detection apparatus 20 and outputs the acquired information representing the exposure time to the imaging unit 13.

Then, the imaging unit 13 performs an imaging operation based on the information representing the exposure time output from the exposure time switching unit 11. The imaging unit 13 outputs the captured image data to the detection apparatus 20. After the end of step S6, the flow of processes goes to step S7.

(Step S7) The image acquiring unit 24 of the detection apparatus 20 acquires the image data output from the imaging device in accordance with the time of the timing signal output from the timing signal generating unit 21 and outputs the acquired image data to the image processing unit 25. After the end of step S6, the flow of processes goes to step S7.

(Step S8) The control unit 22 determines whether the variable i is 1. When it is determined that the variable i is 1 (Yes in step S8), the flow of processes goes to step S9. When it is determined that the variable i is not I (No in step S8), the flow of processes goes to step S11.

(Step S9) When it is determined that the variable i is 1 (Yes in step S8), the image processing unit 25 performs an image process for detecting a traveling lane marking line and an object. The image processing unit 25 first detects edge points in the image data to detect edge image data and then performs a Hough transform on the edge image data to detect linear components. The image processing unit 25 detects continuous segments out of the detected linear components as candidates of the traveling lane marking line. The image processing unit 25 outputs the information representing the detected candidate areas of the objects to the detection unit 26. After the end of step S9, the flow of processes goes to step S10.

(Step S10) The control unit sets the variable i to “2”. After the end of step Sb, the flow of processes goes to step S13.

(Step S11) When it is determined that the variable i is not 1 (No in step S8), the image processing unit 25 performs an image process for detecting headlights. The image processing unit 25 first detects edge points in the image data to detect edge image data and then performs a Hough transform on the edge image data to detect circular components. Then, the image processing unit 25 detects the detected circular components as candidates of the headlights. The image processing unit 25 outputs information representing the detected candidate areas of objects to the detection unit 26. After the end of step S11, the flow of processes goes to step S12.

(Step S12) The control unit 22 sets the variable i to “1”. After the end of step S12, the flow of processes goes to step S13.

(Step S13) The detection unit 26 detects the light-emitting objects such as headlights and the reflecting objects such as traveling lane marking lines based on the information representing the candidate areas of the objects output from the image processing unit 25. The detection unit 26 outputs the detection result to a display unit mounted on a dashboard not shown or a vehicle traveling control unit not shown.

The imaging device 10 and the detection apparatus 20 repeatedly perform the processes of steps S2 to S13 for each frame in accordance with the time of the timing signal output from the timing signal generating unit 21.

Thereafter, the imaging device 10 and the detection apparatus 20 capture an image while alternately switching two exposure times for each frame and detect light-emitting objects or reflecting objects from the captured image data. As a result, the traveling lane marking lines can be detected from the frame obtained with the relatively-long exposure time A and headlights of oncoming vehicles can be detected from the frame obtained with the relatively-short exposure time B.

As the method of extracting predetermined feature points from the captured image and extracting the traveling lane marking lines based on the feature points, known methods described in Patent Document 1, Reference 1 (JP-A-2009-271908), Reference 2 (JP-A-2010-44445), and the like may be performed.

According to the first embodiment of the invention, since an image is captured under the relatively-long exposure time A to image a white line and an image is captured under the relatively-short exposure time B to image headlights, that is, since an image is captured while alternately switching the exposure times, it is possible to appropriately detect the traveling lane marking lines and the headlights (counter lamps or back lights) of oncoming vehicles at night.

By capturing an image with the relatively-short exposure time B, it is possible to detect the traveling lane marking lines and the headlights (counter lamps or back lights) of oncoming vehicles even at night. In addition, when a vehicle is traveling in an urban area, it is possible to prevent undesired light sources such as light from streetlights, light from stores, and light from traffic lights from being captured.

When the relatively-long exposure time A and the relatively-short exposure time B are used even during the daytime, it is possible to appropriately detect the traveling lane marking lines even in circumstances where the luminance difference is small such as when it rains or when time passes after the traveling lane marking lines are drawn.

### Second Embodiment

Although it has been stated in the first embodiment that the exposure time of the imaging device 10 is switched to capture an image, an amplification sensitivity in addition to the exposure time is switched in the second embodiment.

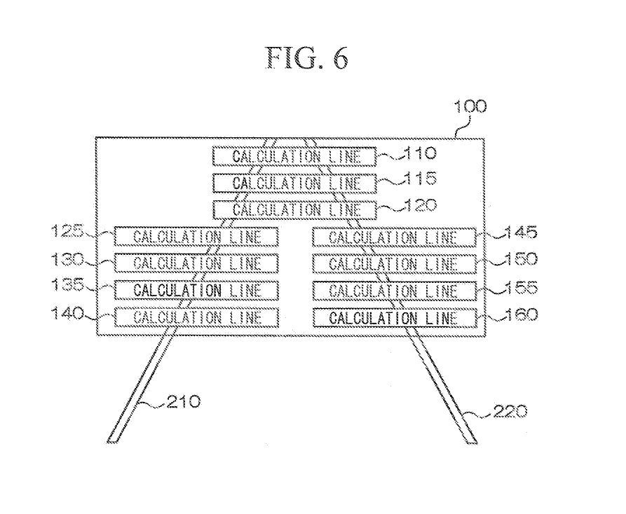

FIG. 6 is a conceptual diagram illustrating the IRIS (Intelligent cooperative Intersection Safety system) used in the detection apparatus in the past. The IRIS is an infrastructure-based intersection safety system providing a red light warning, a left-turning support, a pedestrian protection at right turn, and an emergency vehicle support in the SAFESPOT integrated projects. The SAFESPOT is an integrated project provided with public resources by European Commission information Society Technologies and includes eight types of sub projects.

As shown in FIG. 6, the IRIS determines an image of a road surface area 100 out of the area captured by the imaging device and extracts a range. The absolute luminance of calculation lines 110 to 160 which are areas crossing areas 210 and 220 corresponding to the traveling lane marking lines in the extracted range is calculated, the exposure time which is a shutter speed and the amplification sensitivity (gain) are switched to keep the value of absolute luminance constant, and a feedback control is performed. The gain means an amplification rate, for example, used to amplify electric charges of a CMOS camera to raise the imaging sensitivity when the imaging device is the CMOS camera.

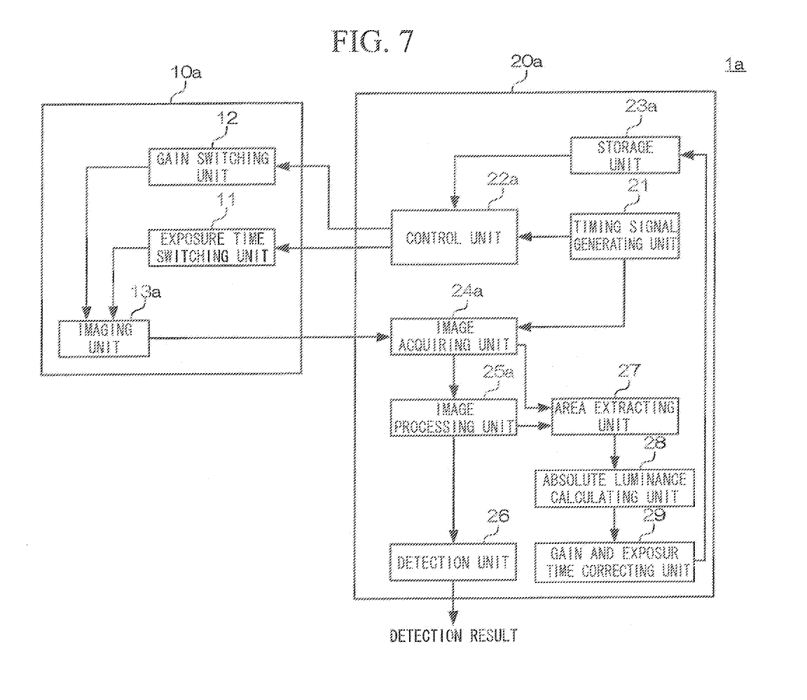

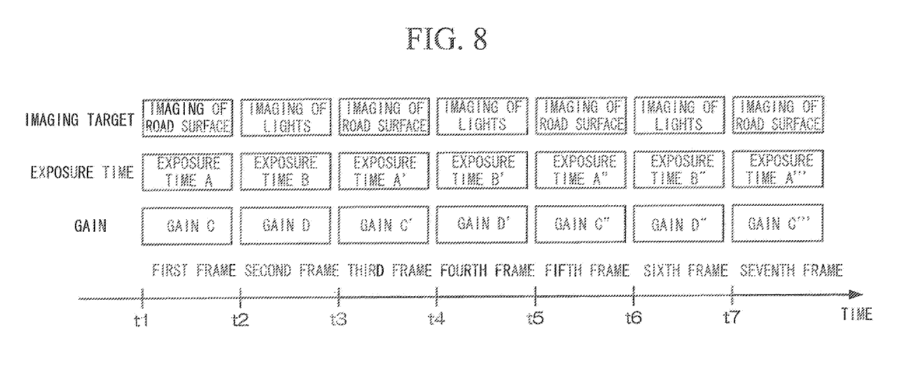

The constitution of a recognition apparatus according to the second embodiment will be described with reference to FIG. 7. FIG. 7 is a block diagram illustrating an example of the constitution of the recognition apparatus according to the second embodiment.

As shown in FIG. 7, the recognition apparatus 1a includes an imaging device 10a and a detection apparatus 20a.

The imaging device 10a includes an exposure time switching unit 11, a gain switching unit 12, and an imaging unit 13a. The detection apparatus 20a includes a timing signal generating unit 21, a control unit 22a, a storage unit 23a, an image acquiring unit 24a, an image processing unit 25a, a detection unit 26, an area extracting unit 27, an absolute luminance calculating unit 28, and a gain and exposure time correcting unit 29. The functional units having the same functions as in the recognition apparatus 1 according to the first embodiment are referenced by the same reference numerals and will not be described.

The constitution of the imaging device 10a will be described below.

The gain switching unit 12 switches the exposure time of the imaging unit 13a based on information representing a gain, which is output from the detection apparatus 20a.

The imaging unit 13a captures an image with the exposure time switched by the exposure time switching unit 11 and the gain switched by the gain switching unit 12 and outputs the captured image data to the detection apparatus 20a.

The constitution of the detection apparatus 20 will be described below.

The control unit 22a reads two exposure times and two gains stored in the storage unit 23a. The control unit 22 alternately outputs information representing the exposure time A and information representing the gain C or information representing the exposure time B and information representing the gain D to the imaging device 10a at the time of the timing signal output from the timing signal generating unit 21.

The storage unit 23a stores the information representing the exposure time A, the information representing the exposure time B, the information representing the gain C, and the information representing the gain D in advance. The gain C is a gain used along with the exposure time A to capture an image with the imaging device 10a. The gain D is a gain used along with the exposure time B to capture an image with the imaging device 10a.

The image acquiring unit 24a acquires image data output from the imaging device 10a at the time of the timing signal output from the timing signal generating unit 21 and converts the acquired image data to digital data. The image acquiring unit 24a outputs the converted image data to the image processing unit 25a and the area extracting unit 27. When the image data output from the imaging device 10a is a digital signal, the image acquiring unit 24a outputs the acquired data to the image processing unit 25a and the area extracting unit 27 without converting the acquired image data.

The image processing unit 25a performs predetermined image processes on the image data output from the image acquiring unit 24a. The image processing unit 25a outputs information representing candidate areas of objects detected through the use of the predetermined image processes to the detection unit 26 and the area extracting unit 27.

The area extracting unit 27 extracts the detected candidate image areas of objects from the image data output from the image acquiring unit 24a based on the information representing the candidate areas of objects, which is output from the image processing unit 25a, and outputs image data of the extracted image areas to the absolute luminance calculating unit 28.

The absolute luminance calculating unit 28 calculates the absolute luminance values (actual luminance) of the image data in the image areas and outputs information representing the calculated absolute luminance value to the gain and exposure time correcting unit 29.

The gain and exposure time correcting unit 29 (correction unit) corrects the gain and the exposure time used in the imaging based on the information representing the absolute luminance value, which is output from the absolute luminance calculating unit 28, and stores the corrected gain and the corrected exposure time in the storage unit 23a.

Imaging targets and exposure times will be described below with reference to FIG. 8. FIG. 8 is a diagram illustrating the relationship among the imaging targets, the exposure time, and the gain according to the second embodiment.

As shown in FIG. 8, the imaging device 10a captures image data of a first frame with the exposure time A and the gain C in the period of times t1 to t2 under the control of the detection apparatus 20a. In this case, since the image is captured under the exposure time A which is a long exposure time, the imaging device 10a captures an image for detecting a road surface.

The imaging device 10a captures image data of a second frame with the exposure time B which is a short exposure time and the gain D in the period of times t2 to t3 under the control of the detection apparatus 20a. In this case, since an image is captured under the short exposure time B, the imaging device 10a captures an image for detecting headlights and the like.

The imaging device 10a captures image data of a third frame with the exposure time A′ and the gain C′ in the period of times t3 to t4 under the control of the detection apparatus 20a. The exposure time A′ is an exposure time obtained by correcting the exposure time A based on the captured image data as described later. The gain C′ is a gain obtained by correcting the gain C based on the captured image data.

The imaging device 10a captures image data of a fourth frame with the exposure time B′ which is a short exposure time and the gain D′ in the period of times t4 to t5 under the control of the detection apparatus 20a.

The exposure time B′ is an exposure time obtained by correcting the exposure time B based on the captured image data as described later. The gain D′ is a gain obtained by correcting the gain D based on the captured image data.

Thereafter, the imaging device 10a captures an image while alternately switching the corrected exposure time A, the gain C, the corrected exposure time B, and the gain D.

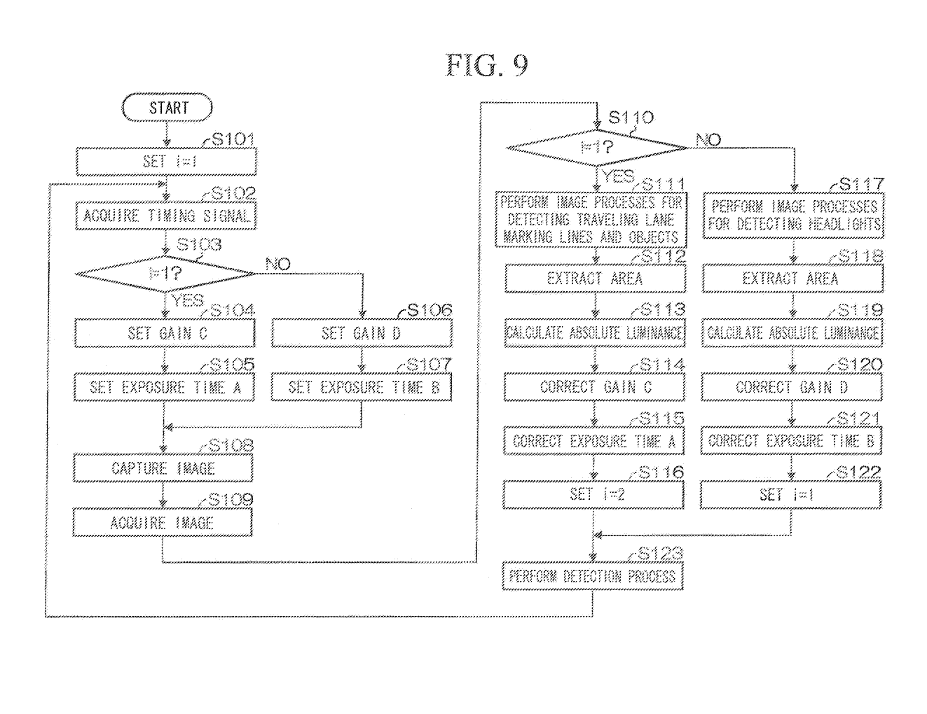

The operation in the second embodiment will be described below with reference to FIG. 9.

FIG. 9 is a flowchart illustrating the operation of the detection apparatus according to the second embodiment.

(Step S101) The control unit 22a of the detection apparatus 20a first sets a variable i for determining which of the exposure times A and B and which of the gains C and D to use to “1”. The processes of step S102 and subsequent steps thereof described below are performed for each frame. After the end of step S101, the flow of processes goes to step S102.

(Step S102) The control unit 22a acquires a timing signal output from the timing signal generating unit 21. After the end of step S102, the flow of processes goes to step S103.

(Step S103) The control unit 22a determines whether the variable i is 1. When it is determined that the variable i is 1 (Yes in step S103), the flow of processes goes to step S104. When it is determined that the variable i is not I (No in step S103), the flow of processes goes to step S106.

(Step S104) When it is determined that the variable i is 1 (Yes in step S103), the control unit 22a outputs the gain C out of the gains read from the storage unit 23a to the imaging device 10a. After the end of step S104, the flow of processes goes to step S105.

(Step S105) The control unit 22a outputs the exposure time A out of the exposure times read from the storage unit 23a to the imaging device 10a. After the end of step S105, the flow of processes goes to step S108.

(Step S106) When it is determined that the variable i is not 1 (No in step S103), the control unit 22a outputs the gain D out of the gains read from the storage unit 23a to the imaging device 10a. After the end of step S106, the flow of processes goes to step S107.

(Step S107) The control unit 22a outputs the exposure time B out of the exposure times read from the storage unit 23a to the imaging device 10a. After the end of step S107, the flow of processes goes to step S108.

(Step S108) The gain switching unit 12 of the imaging device 10a acquires information representing the gain C or D, which is output from the detection apparatus 20a, and outputs the acquired information representing the gain to the imaging unit 13a.

Then, the exposure time switching unit 11 acquires information representing the exposure time A or B, which is output from the detection apparatus 20a, and outputs the acquired information representing the exposure time to the imaging unit 13a.

The imaging unit 13a captures an image based on the information representing the exposure time which is output from the exposure time switching unit 11 and the information representing the gain which is output from the gain switching unit 12. The imaging unit 13a outputs the captured image data to the detection apparatus 20a. After the end of step S108, the flow of processes goes to step S109.

(Step S109) The image acquiring unit 24a of the detection apparatus 20a acquires the image data output from the imaging device 10a at the time of the timing signal output from the timing signal generating unit 21 and outputs the acquired image data to the image processing unit 25a. After the end of step S109, the flow of processes goes to step S110.

(Step S110) The control unit 22a determines whether the variable i is 1. When it is determined that the variable i is 1 (Yes in step S110), the flow of processes goes to step S111. When it is determined that the variable i is not 1 (No in step S110), the flow of processes goes to step S117.

(Step S111) When it is determined that the variable i is 1 (Yes in step S110), the image processing unit 25a performs an image process for detecting the traveling lane marking lines and objects. The image processing unit 25a outputs information representing candidate areas of objects to the detection unit 26. After the end of step S111, the flow of processes goes to step S112.

(Step S112) The area extracting unit 27 extracts image data of the candidate areas of objects from the acquired image data based on the image data output from the image acquiring unit 24a and the information representing the candidate areas of objects which is output from the image processing unit 25a. The areas extracted from the acquired image data are areas representing the traveling lane marking lines and the shapes of streetlights such as the areas 310 to 355 in FIG. 3.

The area extracting unit 27 outputs the extracted image data of the image areas to the absolute luminance calculating unit 28. After the end of step S112, the flow of processes goes to step S113.

(Step S113) The absolute luminance calculating unit 28 calculates the absolute luminance in the image data of the image areas output from the area extracting unit 27 and outputs information representing the calculated absolute luminance to the gain and exposure time correcting unit 29. After the end of step S113, the flow of processes goes to step S114.

(Step S114) The gain and exposure time correcting unit 29 corrects the gain used to capture an image for detecting objects such as the traveling lane marking lines or objects based on the information representing the absolute luminance which is output from the absolute luminance calculating unit 28. The gain and exposure time correcting unit 29 corrects the gain C set in step S104 and stores the corrected gain C′ in the storage unit 23a. After the end of step S114, the flow of processes goes to step S115.

(Step S115) The gain and exposure time correcting unit 29 corrects the exposure time used to capture an image for detecting the traveling lane marking lines or objects based on the information representing the absolute luminance which is output from the absolute luminance calculating unit 28. The gain and exposure time correcting unit 29 corrects the exposure time A set in step S105 and stores the corrected exposure time A′ in the storage unit 23a. After the end of step S115, the flow of processes goes to step S116.

(Step S116) The control unit 22a sets the variable i to “2”. After the end of step S116, the flow of processes goes to step S123.

(Step S117) When it is determined that the variable i is not 1 (No in step S110), the image processing unit 25a performs an image process for detecting headlights. The image processing unit 25a outputs information representing the candidate areas of objects to the detection unit 26. After the end of step S117, the flow of processes goes to step S118.

(Step S118) The area extracting unit 27 extracts image data of the candidate areas from the acquired image data based on the image data output from the image acquiring unit 24a and the information representing the candidate areas of objects which is output from the image processing unit 25a. The areas extracted from the acquired image data are areas representing the shape of headlights such as the areas 470 to 485 in FIG. 4. The area extracting unit 27 outputs the extracted image data of the image areas to the absolute luminance calculating unit 28. After the end of step S118, the flow of processes goes to step S119.

(Step S119) The absolute luminance calculating unit 28 calculates the absolute luminance in the image data of the image areas output from the area extracted unit 27 and outputs information representing the calculated absolute luminance to the gain and exposure time correcting unit 29. After the end of step S119, the flow of processes goes to step S120.

(Step S120) The gain and exposure time correcting unit 29 corrects the gain used to capture an image for detecting objects such as the headlights based on the information representing the absolute luminance which is output from the absolute luminance calculating unit 28. The gain and exposure time correcting unit 29 corrects the gain D set in step S106 and stores the corrected gain D′ in the storage unit 23a. After the end of step S120, the flow of processes goes to step S121.

(Step S121) The gain and exposure time correcting unit 29 corrects the exposure time used to capture an image for detecting objects such as the headlights based on the information representing the absolute luminance which is output from the absolute luminance calculating unit 28. The gain and exposure time correcting unit 29 corrects the exposure time B set in step S107 and stores the corrected exposure time B′ in the storage unit 23a. After the end of step S121, the flow of processes goes to step S122.

(Step S122) The control unit 22a sets the variable i to “1”. After the end of step S122, the flow of processes goes to step S123.

(Step S123) The detection unit 26 detects the light-emitting objects and the reflecting objects based on the information representing the candidate areas of the objects which is output from the image processing unit 25a. The detection unit 26 outputs the detection result to a display unit mounted on a dashboard not shown or a vehicle traveling control unit not shown.

The imaging device 10a and the detection apparatus 20a repeatedly perform the processes of steps S102 to S123 for each frame in accordance with the timing of the timing signal output from the timing signal generating unit 21.

Thereafter, the imaging device 10a and the detection apparatus 20a capture an image while alternately switching two exposure times and two gains for each frame and extract areas including desired objects in the captured image data. The set exposure time and the set gain are corrected based on the absolute luminance of the extracted areas. As a result, since desired objects are detected from the image data captured under the appropriate exposure time and the appropriate gain, it is possible to detect objects with high accuracy even during the daytime, at night, and in the rain.

In the second embodiment, the example where a set of the gain and the exposure time is corrected in steps S114, S115, S120, and S121 have been described. However, only the gain or only the exposure time may be corrected based on the absolute luminance calculated in step S113 or S119.

In this case, the detection apparatus 20a corrects only the exposure time A, for example, based on the image data of the first frame captured in the period of times t1 to t2 in FIG. 8 and calculates the absolute luminance again in step S113 based on the image data of the third frame captured in the period of times t3 to t4. The gain and exposure time correcting unit 29 of the detection apparatus 20a determines whether the absolute luminance of desired objects is satisfactory by correcting only the exposure time A. When it is determined that the exposure time is satisfactory, the gain and exposure time correcting unit 29 stores only the corrected exposure time A′ in the storage unit 23a. On the other hand, when it is determined the absolute luminance is not satisfactory, the gain and exposure time correcting unit 29 also corrects the gain C based on the calculated absolute luminance.

Alternatively, the detection apparatus 20a corrects only the gain C, for example, based on the image data of the first frame captured in the period of times t1 to t2 in FIG. 8 and calculates the absolute luminance again in step S113 based on the image data of the third frame captured in the period of times t3 to t4. The gain and exposure time correcting unit 29 of the detection apparatus 20a determines whether the absolute luminance of desired objects is satisfactory by correcting only the gain C. When it is determined that the exposure time A and the gain C are satisfactory, the gain and exposure time correcting unit 29 stores only the corrected gain C′ in the storage unit 23a. On the other hand, when it is determined the absolute luminance is not satisfactory, the gain and exposure time correcting unit 29 also corrects the exposure time A based on the calculated absolute luminance. In this way, when the gain is corrected and satisfactory luminance cannot be obtained for desired objects by correcting only the gain, the effect of correcting the exposure time is to reduce the variation in shutter speed which is the predetermined exposure time. When the imaging device 10a captures an image and the exposure time is switched, for example, for the first frame, the third frame, and the fifth frame in FIG. 8, a phenomenon that the objects (the back lights, the traveling lane marking lines, or the like) of the captured image data flow may occur. When the flow phenomenon occurs, the detection accuracy of objects may be lowered. Accordingly, by reducing the correction of the exposure time, it is possible to reduce the flow phenomenon of the objects in the image data.

To reduce the flow phenomenon in the image data, for example, the image processing unit 25a may detect the areas of the desired objects and then may determine whether the flow phenomenon occurs in the candidates of the objects of the detected areas through the use of the known image recognition techniques such as pattern matching. When it is determined that the flow phenomenon occurs, the exposure time may be set again to the predetermined exposure time and the gain may be corrected in step S114 or S120.

In the embodiment, the imaging with the long exposure time A and the imaging with the short exposure time B are alternately performed as shown in FIGS. 2 and 8. However, depending on the frame rate of the imaging device 10 or 10a, for example, two frames may be captured under the exposure time A and then two frames may be captured under the exposure time B. Depending on the objects to be detected, for example, two frames may be captured under the exposure time A and then one frame may be captured under the exposure time B. The period Δt1 (=t1 to t2) in which an image is captured under the exposure time A and the period Δt2 (=t2 to t3) in which an image is captured under the exposure time B may be equal to each other or the period Δt2 may be set to be shorter than the period Δt1 depending on the exposure time.

In the embodiment, objects are detected from the image data captured while alternately switching two different exposure times A and B. However, the number of exposure times is not limited to two, but may be three or more depending on the objects to be detected. In this case, an image may be captured while sequentially switching the first exposure time, the second exposure time, and the third exposure time, and objects may be detected from the captured image data. The first exposure time, the second exposure time, and the third exposure time may be set so that the first exposure time is longer than the second exposure time and the third exposure time and the second exposure time may be longer than the third exposure time. Alternatively, the first exposure time, the second exposure time, and the third exposure time may be set so that the first exposure time is longer than the second exposure time and the third exposure time and the third exposure time is longer than the second exposure time. Similarly, the number of gains is not limited to two, but may be three or more.

In the embodiment, the gain of the imaging device 10a is switched, but the sensitivity of image data may be switched under the control of the control unit 22a when the image processing unit 25a performs the image processes.

Programs for realizing the functions of the various units of the detection apparatus 20 shown in FIG. 1 or the detection apparatus 20a shown in FIG. 7 may be recorded on a computer-readable recording medium, and the programs recorded on the recording medium may be read and executed by a computer system to perform the processes of the various units. Here, the “computer system” includes an OS and hardware such as peripherals.

The “computer system” also includes a homepage provision environment (or display environment) when a WWW system is utilized. The “computer-readable recording medium” includes a portable medium such as a flexible disc, a magneto-optical disc, a ROM (Read Only Memory), or a CD-ROM, and USB (Universal Serial Bus), a USB memory connected via I/F (Interface), or a storage device such as a hard disk built in the computer system. Furthermore, the “computer-readable recording medium” also includes a device storing a program for a predetermined time, like an internal volatile memory of a computer system serving as a server or a client. The above-mentioned program may embody a part of the above-mentioned functions, and moreover, the program may embody the above-mentioned functions in cooperation with a program previously recorded in the computer system.

What is claimed is:

1. A detection apparatus comprising:
a control unit configured to switch an exposure time of an imaging device at a predetermined time;
an image acquiring unit configured to acquire image data captured under different exposure times; and
an object detecting unit configured to detect objects from the image data of the different exposure times acquired by the image acquiring unit.

2. The detection apparatus according to claim 1, wherein
the control unit is configured to switch an amplification sensitivity of the imaging device at a predetermined time,
the image acquiring unit is configured to acquire image data captured under different exposure times and different amplification sensitivities, and
the object detecting unit is configured to detect objects from the image data of the different exposure times and the different amplification sensitivities acquired by the image acquiring unit.

3. The detection apparatus according to claim 1, further comprising:
an area extracting unit configured to extract image data of candidate areas of the objects from the image data captured under the different exposure times;
an absolute luminance calculating unit configured to calculate an absolute luminance in the image data of the candidate areas of the objects extracted by the area extracting unit; and
a correction unit configured to correct at least one of the exposure time and the amplification sensitivity based on the absolute luminance in the image data of the candidate areas of the objects calculated by the absolute luminance calculating unit,
wherein the control unit switches the exposure time or amplification sensitivity of the imaging device to the exposure time or amplification sensitivity corrected by the correction unit.

4. The detection apparatus according to claim 1, wherein the different exposure times include a first exposure time and a second exposure time shorter than the first exposure time.

5. The detection apparatus according to claim 4, wherein
the first exposure time is an exposure time used to detect at least a light-emitting object, and
the second exposure time is an exposure time used to detect at least a reflecting object.

6. The detection apparatus according to claim 5, wherein
the light-emitting object is at least a headlight, and
the reflecting object is an object including any one of a traveling lane marking line, a vehicle, and a person on a vehicle traveling road.

7. A detection method in a detection apparatus, comprising:
a control step of causing a control unit to switch an exposure time of an imaging device at a predetermined time;
an image acquiring step of causing an image acquiring unit to acquire image data captured under different exposure times; and
an object detecting step of causing an object detecting unit to detect objects from the image data of the different exposure times acquired in the image acquiring step.
